(19) United States
(12) Patent Application Publication
(10) Pub. No.: US 2026/0110943 A1
(43) Pub. Date: Apr. 23, 2026

(54) TRANSPARENT DISPLAY SCREEN WITH VARIABLE OPACITY

(71) Applicant: AUDI AG, Ingolstadt (DE)

(72) Inventors: Ulrich MÜLLER, Ingolstadt (DE); Tobias MOLL, Ingolstadt (DE)

(21) Appl. No.: 19/355,590

(22) Filed: Oct. 10, 2025

(30) Foreign Application Priority Data
Oct. 17, 2024 (DE) 10 2024 130 260.7

(51) Int. Cl. G02F 1/1677; G02F 1/167

(52) U.S. Cl. CPC G02F 1/1677; G02F 1/167

(57) ABSTRACT

A transparent display screen is disclosed, and may include a transparent substrate, a pixel layer, a full-area opacity layer, and a plurality of electrodes. The transparent substrate may define a display plane and a display direction perpendicular to the display plane. The pixel layer may be supported on the transparent substrate and may have a plurality of opaque light-emitting diodes arranged at a distance from one another in the display plane. The full-area opacity layer may be formed in the transparent substrate and may be arranged behind the display plane with respect to the display direction and extending parallel to the display plane. The plurality of electrodes may be arranged in the full-area opacity layer and behind the opaque light-emitting diodes with respect to the display direction.

### BACKGROUND

### Technical Field

The present disclosure relates to a transparent display screen, specifically a transparent display screen which includes a plurality of opaque light-emitting diodes. Furthermore, the present disclosure relates to a display system.

### Description of the Related Art

Transparent display screens comprising a transparent substrate defining a display plane and a display direction perpendicular to the display plane, and a pixel layer supported on the transparent substrate and having a plurality of opaque light-emitting diodes arranged at a distance from one another in the defined display plane may be used, for example, in head-up displays (“HUDs”) in vehicles.

In contrast, mobile devices such as smartphones and tablets typically use opaque display screens that are also sensitive to touch. For example, WO2017/060487A1 discloses a display screen having a plurality of light-emitting diodes (“LEDs”) arranged in a matrix and at a distance from one another in a transparent substrate. The display screen further comprises a plurality of electrodes forming capacitive touch sensors and arranged between the LEDs.

Instead of LEDs arranged in a matrix, display screens may also be based on electrophoretic pigment particles, i.e., pigment particles that may move in an electric field. For example, US Patent Application Publication No. 2002/0089279A1 discloses a display screen having two transparent layers and an insulating liquid containing charged pigment particles, which is arranged between the transparent layers. A developing head arranged outside the display screen arranges the charged pigment particles to form a display content when the transparent display screen moves relative to the developing head.

A transparent display screen of the type described herein may be integrated into a vehicle windshield providing the transparent substrate, or may be formed separately from the windshield and protrude from a vehicle instrument panel. Due to the transparency, such HUDs enable a user of the HUD to perceive simultaneously a display content displayed by the pixel layer and, through the transparent display screen, a background of the transparent display screen arranged behind the transparent display screen with respect to the user's viewing direction. The user's viewing direction and the display direction of the display screen extend parallel and opposite to each other. The display direction corresponds to a main emission direction of light emitted by the LEDs.

However, these transparent display screens may only display content with high contrast in a random interaction with a dark or, ideally, black background. Although an optionally high-contrast display may be achieved by way of an opacity layer arranged behind the pixel layer with respect to the viewing direction, and which allows for adjusting a substantial opacity of the opacity layer by selectively varying an orientation of pigment particles in the opacity layer by way of an electric field, however, even with a lowest adjustable transparency, i.e., without an electric field, the opacity layer reduces the overall transmissivity of the transparent display screen, which is undesirable.

### BRIEF SUMMARY

The present disclosure provides a transparent display screen that may optionally provide high contrast or high transmissivity. The present disclosure also provides a display system.

The present disclosure provides a transparent display screen which may comprise a transparent substrate defining a display plane and a display direction perpendicular to the display plane, a pixel layer supported on the transparent substrate and having a plurality of opaque LEDs arranged at a distance from one another in the defined display plane, and a full-area opacity layer formed in the transparent substrate and arranged behind the display plane with respect to the display direction and extending parallel to the display plane. In other words, gaps between the LEDs may enable transmissivity of the transparent display screen, while the opacity layer optionally reduces the transmissivity of the transparent display screen. The display plane may generally be understood as a manifold, i.e., a mathematical surface that may also exhibit curvature. In other words, the display plane does not need to be flat.

The transparent substrate may comprise glass or may consist of glass. In some embodiments, a pane, such as a windshield, of a vehicle may provide the transparent substrate. In some embodiments, the transparent display screen may be part of a vehicle's HUD.

Said opaque LEDs may be general LEDs, but not limited thereto. The opaque LEDs may be designed, for example, as organic light-emitting diodes (OLEDs), micro-light-emitting diodes (MicroLEDs), or even as self-emissive quantum dots (QD-LEDs).

According to the present disclosure, the transparent display screen may comprise a plurality of electrodes arranged in the full-area opacity layer and behind the opaque LEDs with respect to the display direction. The electrodes may be fixed in position in the opacity layer.

The plurality of electrodes may not reduce the transmissivity of the transparent display screen because, due to the arrangement thereof, the electrodes may be obscured from the user's viewing direction. The electrodes may be arranged in the optical shadow cast by the opaque LEDs. In short, the transmissivity of the transparent display screen according to the present disclosure may be as high as the transmissivity of a transparent display screen without the electrodes arranged in the opacity layer.

In some embodiments, each electrode may be spatially assigned to exactly one opaque LED. The assignment may result from a spatial relationship between the electrode and the respective opaque LED arranged behind the electrode with respect to the display direction. Each electrode in the opacity layer may be arranged behind an LED. In this way, the transmissivity of the transparent display screen may not be impaired by electrodes arranged in the opacity layer.

Each electrode may be formed as a platelet. A platelet may be understood to mean a body that has a shape with a single main extension direction, i.e., a rod shape, or a shape with a main extension plane, i.e., a tile shape.

Each electrode may extend perpendicular to the display direction or perpendicular to the display plane. If the electrodes extend perpendicular to the display direction, i.e., parallel to the display plane, the extension parallel to the display plane of the electrodes may be less than an extension of the assigned LED in the display plane.

In some embodiments, an opaque LED may be assigned exactly one electrode or a pair of spaced-apart electrodes. A single electrode may generate a monopole electric field. A pair of spaced-apart electrodes may generate a dipole electric field.

Each LED may be configured as a three-color pixel of the transparent display screen. The three-color pixel may be red, green, and blue.

The full-surface opacity layer may be configured as an electrophoresis layer and may comprise a liquid and a plurality of charged, opaque pigment particles that are freely movable in the liquid. The opacity layer may be based on electrophoresis of the charged, opaque pigment particles. If the electrodes are uncharged and do not provide an electromagnetic field, the pigment particles may be evenly distributed in the full-area opacity layer and reduce the transmissivity of the transparent display screen. With uncharged electrodes, the transparent display screen may thus provide a strong contrast for the display content displayed by the pixel layer. Such charged, opaque pigment particles may be known, for example, as electrical ink (“E-ink”).

When the electrodes are charged and provide an electromagnetic field, the pigment particles may align, with respect to the display direction, in front of the opaque LEDs, i.e., with respect to the viewing direction, behind the opaque LEDs, increasing the transmissivity of the transparent display screen. With charged electrodes, the transparent display screen may thus provide high transmissivity of the transparent display screen.

In the transmissive state of the transparent display screen, at least substantially all charged, opaque pigment particles may be obscured by the LEDs from the user's viewing direction. In the transmissive state, the opacity layer may be virtually not perceptible visually.

With respect to the display plane, a ratio of an area portion of the opaque LEDs to an area portion of gaps between the opaque LEDs may be in a range of 30% to 70%, or may be 50%. The ratio may determine the minimum possible transmissivity of the transparent display screen and may be selected depending on the specific application of the transparent display screen.

The transparent display screen may comprise a plurality of electrical control lines that extend from contacts of an electrical connection region of the transparent display screen arranged on an outer side of the transparent display screen to each electrode. The electrical control lines may enable driving individual electrodes individually or driving a group of adjacent electrodes collectively or all electrodes. In this way, the transmissivity of the transparent display screen may be controlled at specific points, in sections, or over the entire area. Each electrode may be driven with varying intensity and thus may continuously vary transmissivity of the transparent display screen. At low drive levels, not all charged opaque pigment particles may accumulate behind an opaque LED with respect to the user's viewing direction.

The control lines may enable extremely flexible operation of the transparent display screen both with regard to the spatial distribution of the transmissivity and with regard to the degree of transmissivity.

The present disclosure further provides a display system which may have an electronic control unit. The electronic control unit may be configured to be electrically connected to a display screen and to control the display screen.

In some embodiments of the present disclosure, the display system may comprise a display screen, the electrodes of which may be electrically connected to the electronic control unit. The display system may be configured to optionally provide high transmissivity or display content with high contrast. It should be understood that the control unit may also be configured to control the LEDs of the pixel layer in a manner known per se.

An advantage of the transparent display screen according to the present disclosure is that the transparent display screen may optionally provide high contrast or high transmissivity. The display screen according to the present disclosure combines two equally desirable, but previously unsatisfactorily compatible, capabilities of transparent display screens.

### BRIEF DESCRIPTION OF THE SEVERAL VIEWS OF THE DRAWINGS

FIG. 1 shows a side view of a transparent display screen according to an embodiment of the present disclosure in an opaque state.

FIG. 2 shows a side view of the transparent display screen shown in FIG. 1 in a transmissive state.

FIG. 3 shows a side view of a transparent display screen according to a second embodiment of the present disclosure in a transmissive state.

FIG. 4 shows a side view of a transparent display screen according to a third embodiment of the present disclosure in a transmissive state.

### DETAILED DESCRIPTION

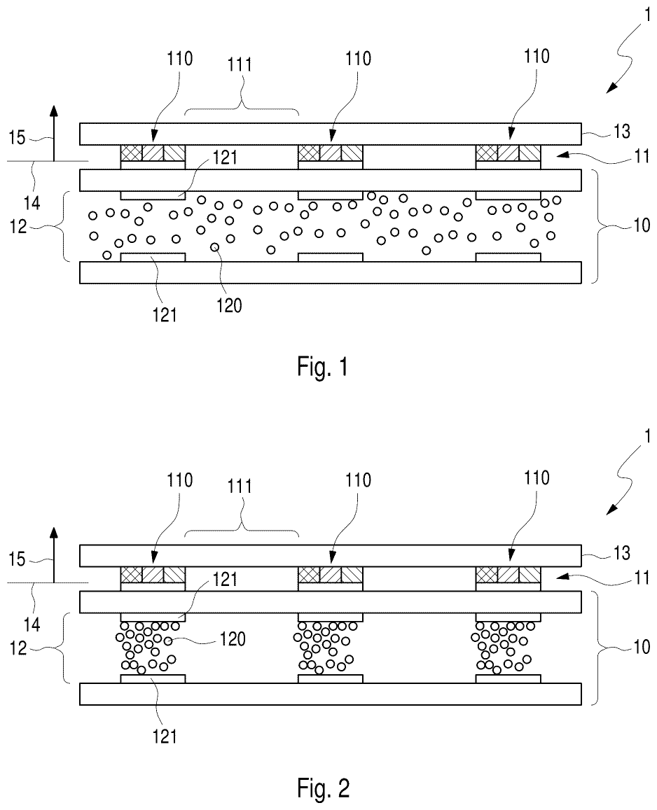

FIG. 1 shows a side view of a transparent display screen 1 according to an embodiment of the present disclosure in an opaque state. Transparent display screen 1 may comprise a transparent substrate 10 that defines a display plane 14 and a display direction 15 perpendicular to display plane 14.

Transparent display screen 1 may further comprise a pixel layer 11 supported on transparent substrate 10 and having a plurality of opaque LEDs 110 arranged at a distance from one another in the defined display plane 14. Accordingly, gaps 111 may be formed between LEDs 110. Each LED 110 may be configured as a three-color pixel of transparent display screen 1. Transparent display screen 1 may include a transparent protective layer 13, which may be arranged behind pixel layer 11 with respect to display direction 14.

With respect to display plane 14, a ratio of an area portion of opaque LEDs 110 to an area portion of gaps 111 between opaque LEDs 110 may be in a range of 30% to 70%, or may be 50%.

Transparent display screen 1 may further include a full-area opacity layer 12 formed in transparent substrate 10 and arranged behind display plane 14 with respect to display direction 15 and extending parallel to display plane 14, and a plurality of electrodes 121 arranged in full-area opacity layer 12 and behind opaque LEDs 110 with respect to display direction 15.

Full-area opacity layer 12 may be configured as an electrophoresis layer and may comprise a liquid and a plurality of charged, opaque pigment particles 120 that are freely movable in the liquid.

Each electrode 121 may be spatially assigned to exactly one opaque LED 110 and/or formed as a platelet. One pair of spaced-apart electrodes 121 may be assigned to one opaque LED 110.

Furthermore, each electrode 121 may extend perpendicular to display direction 15.

Transparent display screen 1 may include a plurality of electrical control lines (not shown) that extend from contacts of an electrical connection region (not shown) of transparent display screen 1 arranged on an outer side of transparent display screen 1 to each electrode 121.

Transparent display screen 1 and an electronic control unit (not shown) may be part of a display system, wherein electrodes 121 of transparent display screen 1 are electrically connected to the electronic control unit.

In the opaque state, the electrodes may be uncharged. Charged opaque pigment particles 120 may be evenly distributed in opaque layer 12.

FIG. 2 shows a side view of transparent display screen 1 shown in FIG. 1 in a transmissive state.

In the transmissive state, electrodes 121 may be charged. Charged opaque pigment particles 120 may be arranged behind opaque LEDs 110 with respect to a user's viewing direction and may not be visually perceptible to the user.

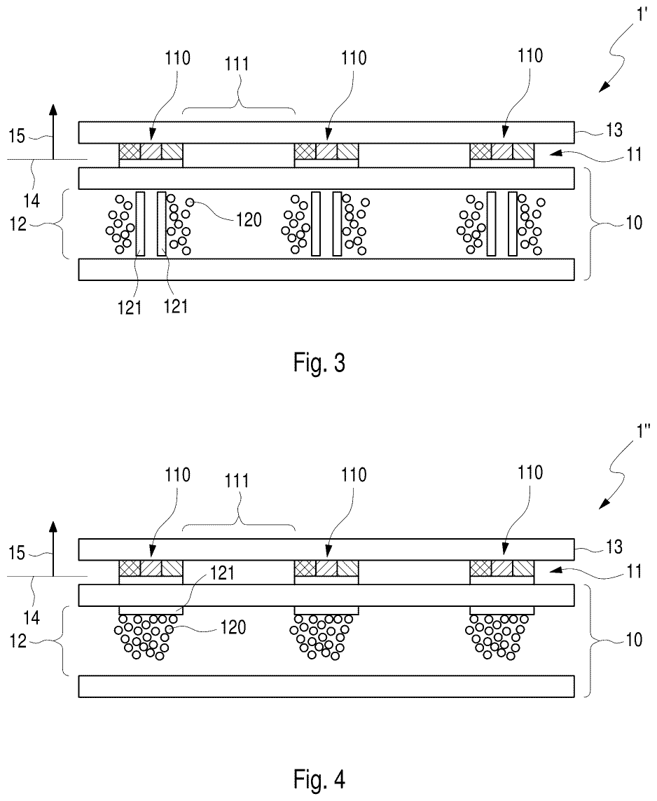

FIG. 3 shows a side view of a transparent display screen 1′ according to a second embodiment of the present disclosure in a transmissive state. Transparent display screen 1′ may have the same basic structure as transparent display screen 1 shown in FIGS. 1 and 2 and differs from it in that each electrode 121 extends perpendicular to display plane 14.

FIG. 4 shows a side view of a transparent display screen 1″ according to a third embodiment of the present disclosure in a transmissive state. Transparent display screen 1″ may have the same basic structure as transparent display screen 1 shown in FIGS. 1 and 2 and differs from it in that exactly one electrode 121 is assigned to one opaque LED 110.

German patent application no. 102024130260.7, filed Oct. 17, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A transparent display screen comprising:
a transparent substrate defining a display plane and a display direction perpendicular to the display plane;
a pixel layer supported on the transparent substrate and having a plurality of opaque light-emitting diodes arranged at a distance from one another in the display plane;
a full-area opacity layer formed in the transparent substrate and arranged behind the display plane with respect to the display direction and extending parallel to the display plane; and
a plurality of electrodes arranged in the full-area opacity layer and behind the opaque light-emitting diodes with respect to the display direction.

2. The transparent display screen according to claim 1, wherein each electrode is positioned behind exactly one opaque light-emitting diode with respect to the display direction.

3. The transparent display screen according to claim 1, wherein each electrode is formed as a platelet.

4. The transparent display screen according to claim 1, wherein each electrode extends perpendicular to the display direction or perpendicular to the display plane.

5. The transparent display screen according to claim 1, wherein an opaque light-emitting diode is positioned in front of exactly one electrode or a pair of spaced-apart electrodes with respect to the display direction.

6. The transparent display screen according to claim 1, wherein each light-emitting diode is a three-color pixel of the transparent display screen.

7. The transparent display screen according to claim 1, wherein the full-area opacity layer is configured as an electrophoresis layer and comprises a liquid and a plurality of charged opaque pigment particles that are freely movable in the liquid.

8. The transparent display screen according to claim 1, wherein an area of the opaque light-emitting diodes of the display plane is in a range of 30% to 70% of an area of gaps between the opaque light-emitting diodes of the display plane.

9. The transparent display screen according to claim 8, wherein the area of the opaque light-emitting diodes of the display plane is 50% of the area of gaps between the opaque light-emitting diodes of the display plane.

10. The transparent display screen according to claim 1, further comprising a plurality of electrical control lines that extend from contacts of an electrical connection region of the transparent display screen to each electrode, the electrical connection region of the transparent display screen arranged on an outer side of the transparent display screen.

11. A display system comprising:
an electronic control unit; and
a display screen including:
a transparent substrate defining a display plane and a display direction perpendicular to the display plane;
a pixel layer supported on the transparent substrate and having a plurality of opaque light-emitting diodes arranged at a distance from one another in the display plane;
a full-area opacity layer formed in the transparent substrate and arranged behind the display plane with respect to the display direction and extending parallel to the display plane; and
a plurality of electrodes arranged in the full-area opacity layer and behind the opaque light-emitting diodes with respect to the display direction,
wherein the electrodes of display screen are electrically connected to the electronic control unit.
